(19) United States
(12) Patent Application Publication
(10) Pub. No.: US 2023/0358527 A1
(43) Pub. Date: Nov. 9, 2023

(54) OPTICAL INTERFERENCE TOMOGRAPHIC IMAGING DEVICE

(71) Applicant: NEC Corporation, Minato-ku, Tokyo (JP)

(72) Inventor: Shigeru NAKAMURA, Tokyo (JP)

(73) Assignee: NEC Corporation, Minato-ku, Tokyo (JP)

(21) Appl. No.: 18/022,015

(22) PCT Filed: Aug. 27, 2020
(86) PCT No.: PCT/JP2020/032367

§ 371 Date: Feb. 17, 2023

(51) Int. Cl. G01B 9/02091; G01B 9/02004; G01B 9/02055

(52) U.S. Cl. CPC G01B 9/02091; G01B 9/02004; G01B 9/02072

(57) ABSTRACT

This optical interference tomographic imaging device comprising: a wavelength swept laser light source; a splitting means for splitting light emitted from the light source into object light and reference light; an irradiation means for directing the object light outputted to an object, and scanning a predetermined range; a light spectral data generation means for generating information regarding the wavelength dependency of the intensity ratio of interfering light of the reference light and the object light that has been directed to the object to be measured and has been scattered; a wavelength dispersion compensation processing means for performing compensation for the information regarding the wavelength dependency generated, the compensation carried out based on the wavelength dispersion difference of the path of the object light path and the path of the reference light; and a cross section structure information generation means for generating cross section structure information of the object.

### TECHNICAL FIELD

The present invention relates to an optical interference tomographic imaging device.

### BACKGROUND ART

An example of the technique for performing tomographic imaging in the vicinity of the surface of the object to be measured includes an optical coherence tomography (OCT) technique. In the OCT technique, tomographic imaging in the vicinity of the surface of the object to be measured is performed using interference between scattered light (hereinafter, also referred to as “backscattered light”) from the inside of the object to be measured when the object to be measured is irradiated with the light beam and reference light beam. In recent years, the application of the OCT technique to medical diagnosis and industrial product inspection has been expanded.

In the OCT technique, a position in an optical axis direction, that is, a depth direction of a portion (light scattering point) where the object light beam is scattered in the object to be measured is identified by using interference between the object light beam irradiated to and scattered by the object to be measured and the reference light beam, thereby obtaining structure data spatially resolved in the depth direction inside the object to be measured. Examples of the OCT technique include a time domain (TD-OCT) system and a Fourier domain (FD-OCT) system, and the FD-OCT system is more promising in terms of high speed and high sensitivity. In the FD-OCT method, when object light beam and reference light beam are caused to interfere with each other, an interference light spectrum in a wide wavelength band is measured, and Fourier transform is performed on the interference light spectrum to obtain structure data in the depth direction. Examples of the method for obtaining an interference light spectrum include a spectral domain (SD-OCT) method using a spectrometer and a swept source (SS-OCT) method using a light source that sweeps a wavelength.

Furthermore, by scanning the object light beam radiation position of the object to be measured in an in-plane direction perpendicular to the depth direction of the object to be measured, it is possible to obtain tomographic structure data spatially resolved in the in-plane direction and spatially resolved in the depth direction, that is, three-dimensional tomographic structure data of the object to be measured.

The OCT technique has been put into practical use as a tomographic imaging device for the fundus in ophthalmic diagnosis, and has been studied to be applied as a non-invasive tomographic imaging device for various parts of a living body.

FIG. 6 illustrates a typical configuration of an SS-OCT optical interference tomographic imaging device. A wavelength-swept light pulse is generated from a wavelength swept laser light source 501. The light emitted from the wavelength swept laser light source 501 is split into an object light beam R111 and a reference light beam R121 in an optical splitting/merging unit 503 via a circulator 502. The object light beam R111 passes through a fiber collimator 504 and an irradiation optical system 505 including a scanning mirror and a lens, and is applied to an object to be measured 520. Then, an object light beam R131 scattered by the object to be measured 520 returns to the optical splitting/merging unit 503. On the other hand, the reference light beam R121 returns to the optical splitting/merging unit 503 via a reference light beam mirror 506. Therefore, in the optical splitting/merging unit 503, the object light beam R131 scattered by the object to be measured 520 and reference light beam R141 reflected from the reference light beam mirror 506 interfere with each other to generate interference light beam R151 and R161. That is, the intensity ratio between the interference light beam R151 and the interference light beam R161 is determined by the phase difference between the object light beam R131 and the reference light beam R141. The interference light beam R151 passes through the circulator 502 and is input to, and the interference light beam R161 is directly input to a two-input balance type light receiver 507.

By measuring the change in the intensity ratio between the interference light beam R151 and the interference light beam R161 accompanying the wavelength change of the light emitted from the wavelength swept laser light source 501, the interference light spectrum data is obtained. The wavelength dependency of the photoelectric conversion output of the balance type light receiver 507 represents the interference light spectrum. By measuring the interference light spectrum and performing Fourier transform on it, data indicating the intensity of the backscattered light (object light beam) at different positions in the depth direction (Z direction) can be obtained (hereinafter, the operation of obtaining data indicating the intensity of the backscattered light (object light beam) in the depth direction (Z direction) at a certain position of the object to be measured 520 is referred to as an “A scan”).

Interference between object light beam having a wavelength λ and a wave number k (=2π/λ) and reference light beam is considered. In a case where the optical path length until the reference light beam is reflected by the reference light beam mirror 506 and returns to the optical splitting/merging unit 503 after the reference light beam is split at the optical splitting/merging unit 503 is P_{R}, and the optical path length until the object light beam is backscattered at one light scattering point of the object to be measured 520 and returns to the optical splitting/merging unit 503 after the object light beam is split at the optical splitting/merging unit 503 is P_{S}=P_{R}+z₀, the object light beam R131 and the reference light beam R141 interfering at the optical splitting/merging unit 503 interfere with each other at a phase difference kz₀+φ. Here, φ is a constant that does not depend on k or z₀. The amplitude of the object light beam R131 is denoted by E_{S} and the amplitude of the reference light beam R141 is denoted by E_{R}, where they interfere with each other at the optical splitting/merging unit 503.

I(k)∝E_{S}·E_{R}cos(kz₀+φ) [Math. 1]

The intensity difference between the interference light beam R151 and the interference light beam R161 represented by above expression is photoelectrically converted by the balance type light receiver 507. A light spectrum data generation unit 508 generates interference light spectrum data based on the information on the wavelength change of the emission light from the wavelength swept laser light source 501 and the information on the intensity difference between the interference light beam R151 and the interference light beam R161 from the balance type light receiver 507. The modulation with the period 2π/z₀ appears in the interference light spectrum data I(k) obtained by measuring from the wave number k₀−Δk/2 to k₀+Δk/2. The obtained interference light spectrum data is transmitted from the light spectrum data generation unit 508 to an A scan waveform generation unit 509.

The A scan waveform generation unit 509 performs Fourier transform on the interference light spectrum data. The amplitude J(z) of the Fourier transform of I(k) is expressed as follows.

J(z)=|∫I(k)e^{izk}dk|∝δ(z−z₀)+δ(z+z₀) [Math. 2]

A peak of a δ function is shown at z=z₀ (and z=−z₀) reflecting a light scattering point position z₀.

When the object to be measured is a mirror, the light scattering point is located at one position. However, in general, the object light beam irradiated to the object to be measured is sequentially backscattered while being attenuated and propagating into the inside to some extent, and the light scattering points of the object light beam are distributed in a range from the surface to a certain depth. In the case where the light scattering points are distributed from z₀−Δz to z₀+Δz in the depth direction, the modulation from the period 2π/(z₀−Δz) to 2π/(z₀+Δz) appears in an overlapping manner in the interference light spectrum.

Further, the radiation position of the object light beam R111 is scanned on the object to be measured 520 by the irradiation optical system 505. By repeatedly performing the A scan operation while moving the radiation position of the object light beam R111 in the scanning line direction (X direction) by the irradiation optical system 505 and connecting the measurement results, a map of two-dimensional intensity of backscattered light (object light beam) in the scanning line direction and the depth direction is obtained as tomographic structure data (hereinafter, the operation of repeatedly performing the A scan operation in the scanning line direction (X direction) and connecting the measurement results is referred to as a “B scan”).

Further, by repeatedly performing the B scan operation while moving the radiation position of the object light beam R111 not only in the scanning line direction but also in the direction (Y direction) perpendicular to the scanning line by the irradiation optical system 505, and connecting the measurement results, three-dimensional tomographic structure data is obtained (hereinafter, the operation of repeatedly performing the B scan operation in the direction perpendicular to the scanning line (Y direction) and connecting the measurement results is referred to as a “C scan”).

In a case where the living body is an object to be measured, it is usually difficult to perform measurement while completely fixing the living body, and thus, it is necessary to perform measurement at high speed. In a case where a wide range of measurement is required, it is difficult to measure a wide range at a high speed only by perform scanning with one object light beam at a high speed. Therefore, a configuration in which a plurality of object light beams is irradiated has been proposed (PTL 1). A plurality of object light beams simultaneously scans a plurality of different regions of the object to be measured to perform measurement, thereby enabling high-speed measurement in a wide range.

PTL 2 relates to an optical measurement method, and offers an OCT device including an optical probe. PTL 3 relates to a system for generating data using endoscopic microscopy, and offers an OCT device including a multimode fiber.

### CITATION LIST

### Patent Literature

[PTL 1] JP 2010-167253 A
[PTL 2] JP 2014-025953 A
[PTL 3] JP 2009-523574 A

### SUMMARY OF INVENTION

### Technical Problem

The inventors have found that it is possible to achieve an irradiation optical system used for irradiation with a plurality of object light beams without changing an irradiation optical system used for irradiation with a single object light beam by connecting a multi-core optical fiber to a fiber collimator placed before the irradiation optical system. The inventors have found the problem that the difference in the wavelength dispersion between the optical path of the object light beam using the multi-core optical fiber (MCF) and the optical path of the reference light beam using the standard single mode optical fiber (SMF) adversely affects the spatial resolution in the depth direction. In PTLs 1 to 3, no description about attention to this problem and means for solving the problem is not found.

An object of the present invention is to provide a configuration for suppressing degradation in spatial resolution in a case where wavelength dispersion of an optical path of an object light beam and wavelength dispersion of an optical path of a reference light beam are different in an optical interference tomographic imaging device.

### Solution to Problem

In order to achieve the above object, an optical interference tomographic imaging device according to the present invention includes a wavelength swept laser light source, a splitting means configured to split light emitted from the wavelength swept laser light source into an object light beam and a reference light beam, an irradiation means configured to irradiate an object to be measured with the object light beam output from the splitting means, and scan a predetermined range, a light spectrum data generation means configured to generate information on wavelength dependency of an intensity ratio of an interference light beam between an object light beam, irradiated to and scattered by the object to be measured, and the reference light beam, a wavelength dispersion compensation processing means configured to perform compensation for information on the wavelength dependency of the intensity ratio of the interference light beam generated by the light spectrum data generation means, the compensation being carried out by using a multiplication process based on a difference in wavelength dispersion of an optical path of the object light beam and an optical path of the reference light beam, and a tomographic structure information generation means configured to generate tomographic structure information on the object to be measured, based on a result of the wavelength dispersion compensation process.

### Advantageous Effects of Invention

The optical interference tomographic imaging device according to the present invention suppresses degradation in spatial resolution even in a case where wavelength dispersion of an optical path of an object light beam is different from wavelength dispersion of an optical path of a reference light beam, such as when a multi-core optical fiber is used to irradiate an object to be measured with a plurality of object light beams.

### BRIEF DESCRIPTION OF DRAWINGS

FIG. 1 is a diagram illustrating a configuration of an optical interference tomographic imaging device according to an example embodiment of a superordinate concept of the present invention.

FIG. 2 is a diagram illustrating a configuration of an example of the first example embodiment of the optical interference tomographic imaging device according to the present invention.

FIG. 3 is a diagram illustrating an effect of a wavelength dispersion compensation process on an A scan waveform obtained by the optical interference tomographic imaging device according to the present invention.

FIG. 4 is a diagram illustrating a configuration of an example of a second example embodiment of the optical interference tomographic imaging device according to the present invention.

FIG. 5 is a diagram illustrating a configuration example of a coherent light receiver used in the second example embodiment of the optical interference tomographic imaging device according to the present invention.

FIG. 6 is a view illustrating an example of a related optical interference tomographic imaging device.

### EXAMPLE EMBODIMENT

Hereinafter, example embodiments of the present invention will be described with reference to the drawings. Before describing specific example embodiments, an example embodiment of a superordinate concept of the present invention will be described.

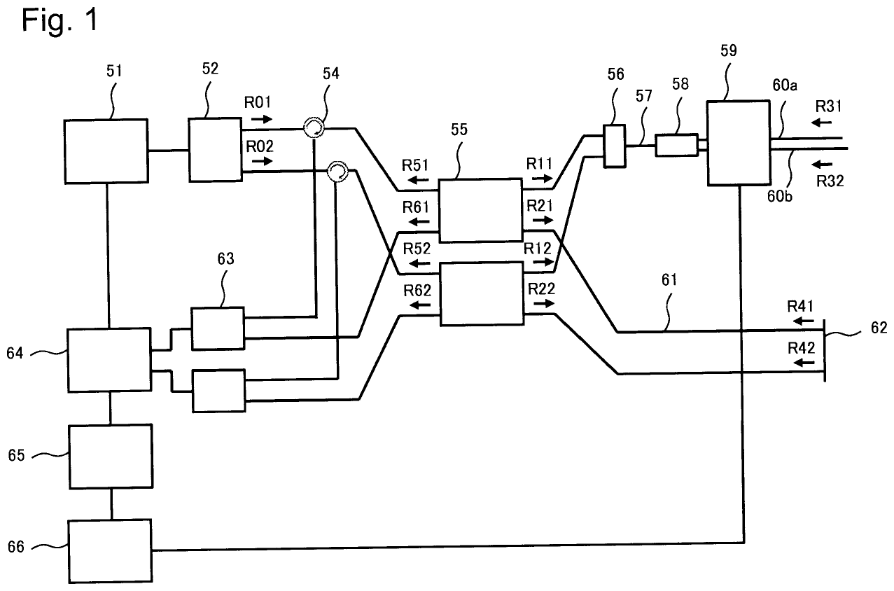

FIG. 1 is a configuration diagram illustrating an optical interference tomographic imaging device according to an example embodiment of a superordinate concept of the present invention. The optical interference tomographic imaging device of FIG. 1 includes a wavelength swept laser light source 51, an optical splitter 52, a plurality of circulators 54, a plurality of optical splitting/merging unit 55, and an optical connection unit 56 between a plurality of single mode fibers (SMF) and a single multi-core optical fiber (MCF). The optical interference tomographic imaging device of FIG. 1 includes an MCF 57, a fiber collimator 58, an irradiation optical system 59, a plurality of SMFs 61 used for a reference light beam path, a reference light beam mirror 62, a balance type light receiver 63, and a light spectrum data generation means 64. The optical interference tomographic imaging device of FIG. 1 further includes a wavelength dispersion compensation processing means 65 and a control means 66. The irradiation optical system 59 of the optical interference tomographic imaging device in FIG. 1 may have at least a configuration used for irradiation with a single object light beam. In the optical interference tomographic imaging device of FIG. 1, the plurality of circulators 54 is disposed between the optical splitter 52 and the plurality of optical splitting/merging units 55, but the present invention is not limited thereto, and the plurality of circulators may be disposed between the plurality of optical splitting/merging units 55 and the optical connection unit 56.

In the optical interference tomographic imaging device of FIG. 1, the wavelength swept laser light source 51, the optical splitter 52, the plurality of circulators 54, the plurality of optical splitting/merging units 55, the optical connection unit 56, the MCF 57, the fiber collimator 58, the irradiation optical system 59, the plurality of SMFs 61 used for a reference light beam path, the reference light beam mirror 62, and the balance type light receiver 63 will be described in detail in the example embodiment to be described later.

The light spectrum data generation means 64 of the optical interference tomographic imaging device of FIG. 1 generates the interference light spectrum based on the information on the wavelength change of the laser light incident on the optical splitter 52 and the information on the change in the intensity ratio between the interference light beams R51 and R61 from the balance type light receiver 63. Similarly, the light spectrum data generation means 64 generates the interference light spectrum based on the information on the wavelength change of the light incident on the optical splitter 52 and the information on the change in the intensity ratio between the interference light beams R52 and R62. The light spectrum data generation means 64 generates interference light spectrum data related to the object to be measured by connecting the generated interference light spectra.

The control means 66 controls the irradiation optical system 59 in such a way as to move the object light beams R11 and R12 in the scanning line direction and the direction perpendicular to the scanning line on one plane of the object to be measured. Preferably, the control means 66 controls a period and a speed at which the irradiation optical system 59 scans the object to be measured.

The wavelength dispersion compensation processing means 65 compensates for a difference between the wavelength dispersion of the optical path of the object light beam and the wavelength dispersion of the optical path of the reference light beam due to the use of the MCF 57 when irradiating the object to be measured with the plurality of object light beams R11 and R12.

According to the optical interference tomographic imaging device of FIG. 1, it is possible to achieve an irradiation optical system used for irradiation with a plurality of object light beams without changing an irradiation optical system used for irradiation with a single object light beam. Since the wavelength dispersion compensation processing means 65 compensate for the difference between the wavelength dispersion of the optical path of the object light beam and the wavelength dispersion of the optical path of the reference light beam due to the use of the MCF 57 when irradiating the object to be measured with the plurality of object light beams R11 and R12, it is possible to suppress degradation in position resolution due to the difference in the wavelength dispersion. Hereinafter, specific example embodiments will be described.

### First Example Embodiment

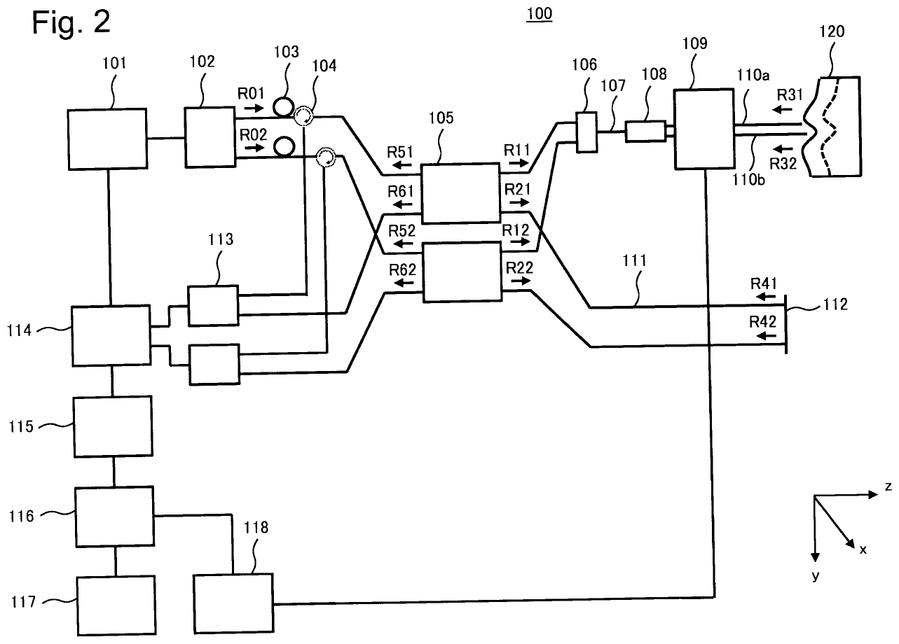

FIG. 2 is a configuration diagram illustrating the first example embodiment of the optical interference tomographic imaging device according to the present invention. As illustrated in FIG. 2, an optical interference tomographic imaging device 100 includes a wavelength swept laser light source 101, an optical splitter 102, a plurality of optical delayers 103, a plurality of circulators 104, a plurality of optical splitting/merging units 105, and an optical connection unit 106 between a plurality of single mode fibers (SMF) and a single multi-core optical fiber (MCF). Furthermore, the optical interference tomographic imaging device 100 includes an MCF 107, a fiber collimator 108, an irradiation optical system 109, a plurality of SMFs 111 used for a reference light beam path, a reference light beam mirror 112, a balance type light receiver 113, and a light spectrum data generation unit 114. The optical interference tomographic imaging device 100 further includes a wavelength dispersion compensation processing unit 115, an A scan waveform generation unit 116, a tomographic image generation unit 117, an object light beam radiation position setting unit 118, and the like.

The wavelength swept laser light source 101 generates a wavelength-swept light pulse. Specifically, the wavelength swept laser light source 101 generates light pulses whose wavelength increases from 1250 nm to 1350 nm for a duration of 10 μs. The wavelength swept laser light source 101 generates the light pulses repeatedly at 50 kHz every 20 μs.

The light emitted from the wavelength swept laser light source 101 is split into a plurality of light beams R01 and R02 by the optical splitter 102, and then is split into object light beams R11 and R12 and reference light beams R21 and R22 by the plurality of optical splitting/merging units 105 via the plurality of optical delayers 103 and the plurality of circulators 104.

The plurality of object light beams R11 and R12 output from the optical splitting/merging units 105 is irradiated to an object to be measured 120 via the optical connection unit 106, the MCF 107, the fiber collimator 108, and the irradiation optical system 109, and scan is performed. More specifically, the irradiation optical system 109 includes a scanning mirror and a lens, and irradiates different positions on the X-Y plane of the object to be measured 120 with the plurality of object light beams 110a and 110b to scan a certain range.

The object light beams 110a and 110b with which the object to be measured 120 is irradiated are scattered backward (in a direction opposite to the radiation direction of the object light beam) from the object to be measured 120. Then, the object light beams (backscattered light) R31 and R32 scattered from the object to be measured 120 return to the optical splitting/merging unit 105 via the irradiation optical system 109 and the MCF 107.

The plurality of reference light beams R41 and R42 output from the optical splitting/merging unit 105 is reflected by the reference light beam mirror 112 and return to the optical splitting/merging unit 105.

Therefore, in the optical splitting/merging unit 105, the object light beam R31 scattered from the object to be measured 120 and the reference light beam R41 reflected from the reference light beam mirror 112 interfere with each other, and the interference light beam R51 and the interference light beam R61 are obtained. Similarly, in the optical splitting/merging unit 105, the object light beam R32 scattered from the object to be measured 120 and the reference light beam R42 reflected from the reference light beam mirror 112 interfere with each other, and the interference light beam R52 and the interference light beam R62 are obtained. Therefore, the intensity ratio between the interference light beam R51 and the interference light beam R61 is determined by the phase difference between the object light beam R31 and the reference light beam R41, and the intensity ratio between the interference light beam R52 and the interference light beam R62 is determined by the phase difference between the object light beam R32 and the reference light beam R42.

The interference light beams R51 and R52 pass through the circulator 104 and is input to, and the interference light beams R61 and R62 are directly input to the related balance type light receiver 113. Then, the information on the change in the intensity ratio between the interference light beam R51 and the interference light beam R61 and the information on the change in the intensity ratio between the interference light beam R52 and the interference light beam R62 are input from the balance type light receiver 113 to the light spectrum data generation unit 114.

The balance type light receiver 113 is a light receiver in which two photodiodes are connected in series and the connection is an output (differential output). The band of the balance type light receiver 113 is 1 GHz or less.

The light spectrum data generation unit 114 generates interference light spectrum data based on the information on the wavelength change of the emission light from the wavelength swept laser light source 101 and the information on the change in the intensity ratio between the interference light beams R51 and R61. Similarly, the light spectrum data generation unit 114 generates an interference light spectrum based on the information on the wavelength change of the emission light from the wavelength swept laser light source 101 and the information on the change in the intensity ratio between the interference light beams R52 and R62. The interference light spectrum data generated by the light spectrum data generation unit 114 is input to the A scan waveform generation unit 116 via the wavelength dispersion compensation processing unit 115.

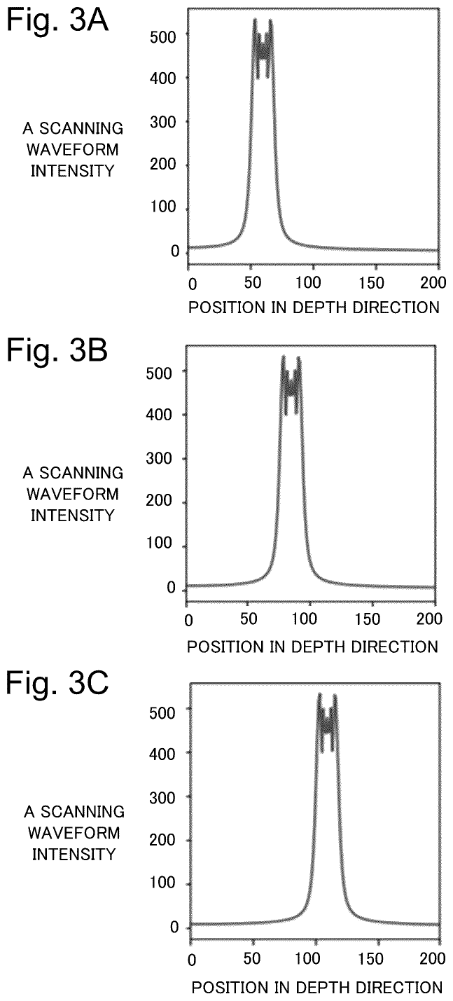

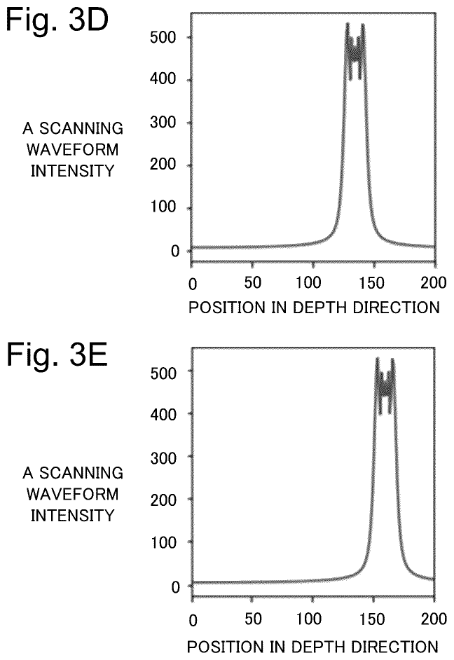

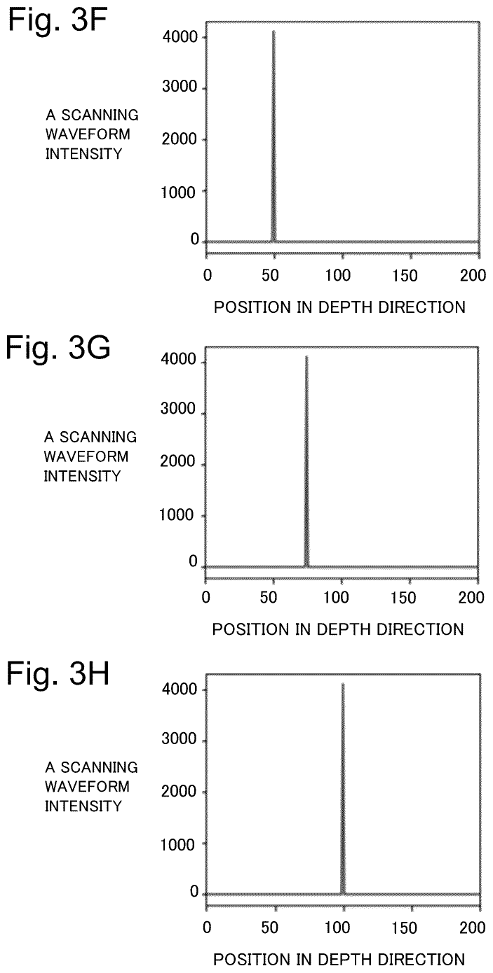

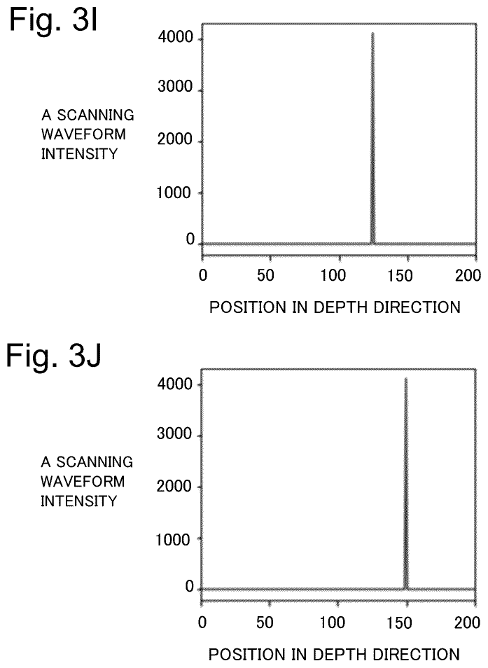

In order to describe the effect of the wavelength dispersion compensation processing unit 115, first, regarding the A scan waveform generated without passing through the wavelength dispersion compensation processing unit 115, a waveform obtained in the case of one light scattering point is illustrated in FIG. 3. (a) to (e) of FIG. 3 illustrate A scan waveforms in a case where the light scattering points are at different positions. The light scattering point is located at one position, but the A scan waveform has a spread, and indicates degradation in position resolution in the depth direction.

A cause of degradation of the position resolution in the A scan waveform generated without passing through the wavelength dispersion compensation processing unit 115 will be described below. The SMF is used for an optical path until the reference light beam is reflected by the reference light beam mirror 112 and returns to the optical splitting/merging unit 105 to interfere with the object light beam after the reference light beam is split by the optical splitting/merging unit 105, and the optical path length is P_{R}. On the other hand, the SMF having the length L₁ and the optical path length P₁, and the MCF having the length L₂ and the optical path length P₂ are used for the optical path until the object light beam is backscattered at one light scattering point of the object to be measured 120 and returns to the optical splitting/merging unit 105 to interfere with the reference light beam after the object light beam is split by the optical splitting/merging unit 105, and the optical path length is P_{S}=P₁+P₂+z₀. Here, P₂=P_{R}−P₁ is satisfied at a certain wavelength λ₀ and a certain wave number k₀, but P₂=P_{R}−P₁ is not necessarily satisfied at any wavelength λ and wave number k in the wavelength sweep range.

This is because the wavelength dispersion of the MCF forming the optical path length P₂ and the wavelength dispersion of the SMF forming the optical path length P_{R}−P₁ are different. The phase difference between the object light beam and the reference light beam interfering at the optical splitting/merging unit 105 is k₀z₀+φ at the wavelength λ₀ and the wave number k₀, while it is kz₀+k(P₁+P₂−P_{R})+φ at any wavelength λ and wave number k. Here, φ is a constant that does not depend on k or z₀. Using the equivalent refractive index n_{M} of the MCF, the equivalent refractive index n_{S} of the SMF, and the difference Δn thereof, the following is expressed.

P₁+P₂−P_{R}=n_{M}L₁−n_{S}(L₂−L_{R})=ΔnL

It is conceivable that Δn has k dependency. In the wavelength range of 1250 nm to 1350 nm, An increases as the wavelength decreases, and can be approximately expressed as Δn˜αk (α>0) as k dependency. As described above, when the amplitude of the object light beam interfering at the optical splitting/merging unit 105 is denoted by E_{S} and the amplitude of the reference light beam is denoted by E_{R}, the generated interference light spectrum is expressed as follows.

I(k)∝E_{S}·E_{R}·cos(kz₀+kΔnL+φ) [Math. 3]

kΔnL appears in the phase term, which is not proportional to k. In the A scan waveform obtained by Fourier-transforming this, degradation in position resolution occurs as illustrated in (a) to (e) of FIG. 3.

Therefore, in the example embodiment of the present invention, the A scan waveform is generated via the wavelength dispersion compensation processing unit 115. The wavelength dispersion compensation processing unit 115 performs the following multiplication process using k dependency of Δn grasped in advance.

I(k)·exp(−ikΔnL)∝E_{S}·E_{R}·cos(kz₀+kΔnL+ϕ)·exp(−ikΔnL) [Math. 4]

By the Fourier transform performed by the A scan waveform generation unit 116 in the subsequent stage, the following is expressed.

J(z)=|∫I(k)e^{-iΔnLk}e^{izk}dk)∝δ(z−z₀)+f(z) [Math. 5]

As illustrated in (f) to (j) of FIG. 3, a peak of a δ function is shown at z=z₀ (and z=−z₀), and the A scan waveform for one light scattering point position is obtained without degradation in position resolution.

In general, the object light beam irradiated to the object to be measured is sequentially backscattered while being attenuated and propagating into the inside to some extent, and the light scattering points of the object light beam are distributed in a range from the surface to a certain depth. In a case where the light scattering points are distributed from z₀−Δx to z₀+Δz in the depth direction, modulation from the period 2π/(z₀−Δz) to 2π/(z₀+Δz) appears in an overlapping manner in the interference light spectrum, and this forms the A scan waveform.

The A scan waveform generation unit 116 generates an A scan waveform. The A scan waveform generation is repeatedly performed while the radiation positions of the object light beams R11 and R12 are moved in the scanning line direction (X direction) by the irradiation optical system 109 based on the control by the object light beam radiation position setting unit 118, and by connecting the measurement results, a map of the two-dimensional intensity of the backscattered light (object light beam) in the scanning line direction and the depth direction is obtained as the B scan tomographic structure data.

Furthermore, the tomographic image generation unit 117 generates three-dimensional tomographic structure data in the X, Y, and Z directions (C scan) by connecting measurement results obtained by repeatedly performing the B scan operation while moving the radiation positions of the object light beams R11 and R12 in the scanning line direction and the direction perpendicular to the scanning line based on the control by the object light beam radiation position setting unit 118.

### (Effects of Example Embodiment)

In the optical interference tomographic imaging device 100 of FIG. 2, the plurality of object light beams R11 and R12 output from the optical splitting/merging unit 105 is coupled in the MCF 107 by the optical connection unit 106, and is irradiated to the object to be measured 120 via the irradiation optical system 109 and scan is performed. As a result, it is possible to achieve the irradiation optical system used for the irradiation with the plurality of object light beams without changing the irradiation optical system used for the irradiation with the single object light beam.

Since the wavelength dispersion compensation processing unit 115 compensates for the difference between the wavelength dispersion of the optical path of the object light beam and the wavelength dispersion of the optical path of the reference light beam due to the use of the MCF 107 when irradiating the object to be measured 120 with the plurality of object light beams R11 and R12, it is possible to suppress degradation in position resolution due to the difference in the wavelength dispersion. Even in a case where the wavelength dispersion of the optical path of the object light beam and the wavelength dispersion of the optical path of the reference light beam are different, for example, when the MCF 107 is used for irradiating the object to be measured 120 with the plurality of object light beams R11 and R12, degradation in the spatial resolution of the scanning waveform can be suppressed by compensating for the difference in the wavelength dispersion.

### Second Example Embodiment

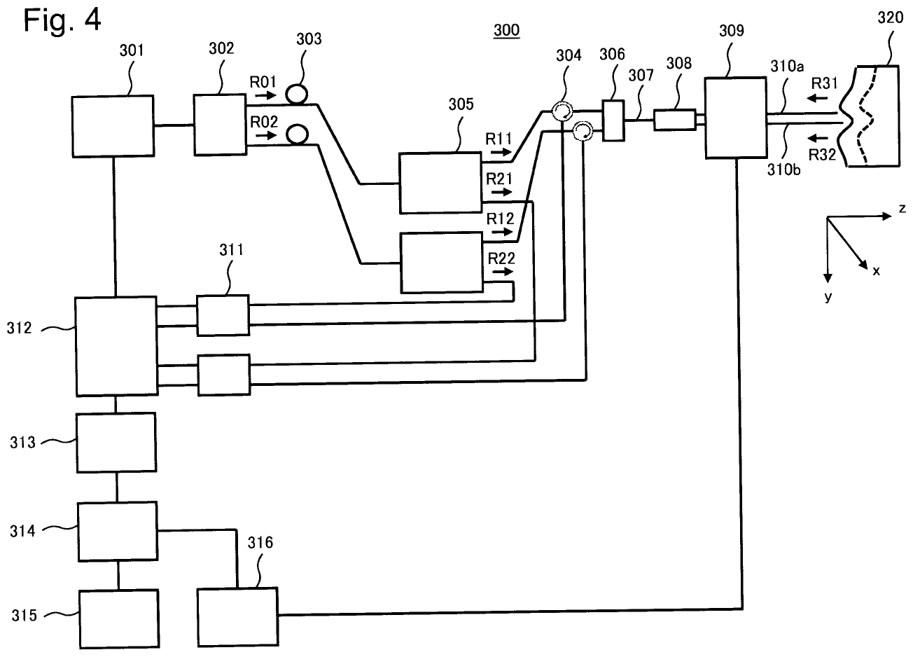

An optical interference tomographic imaging device 300 according to the second example embodiment of the present invention will be described. FIG. 4 is a diagram illustrating an example of the optical interference tomographic imaging device 300 according to the second example embodiment.

As illustrated in FIG. 4, the optical interference tomographic imaging device 300 includes a wavelength swept laser light source 301, a first optical splitter 302, a plurality of optical delayers 303, a plurality of second optical splitters 305, a plurality of circulators 304, and an optical connection unit 306 between a plurality of single mode fibers (SMF) and a single multi-core optical fiber (MCF). The optical interference tomographic imaging device 300 further includes an MCF 307, a fiber collimator 308, an irradiation optical system 309, a coherent light receiver 311, and a light spectrum data generation unit 312. The optical interference tomographic imaging device 300 further includes a wavelength dispersion compensation processing unit 313, an A scan waveform generation unit 314, a tomographic image generation unit 315, an object light beam radiation position setting unit 316, and the like.

The wavelength swept laser light source 301 generates a wavelength-swept light pulse. Specifically, the wavelength swept laser light source 301 generates light pulses whose wavelength increases from 1250 nm to 1350 nm for a duration of 10 μs. The wavelength swept laser light source 301 generates the light pulses repeatedly at 50 kHz every 20 μs.

The light emitted from the wavelength swept laser light source 301 is split into a plurality of light beams R01 and R02 by the first optical splitter 302, and then split into object light beams R11 and R12 and reference light beams R21 and R22 by the plurality of second optical splitters 305 via the plurality of optical delayers 303.

The plurality of object light beams R11 and R12 output from the second optical splitter 305 is irradiated to an object to be measured 320 via the plurality of circulators 304, the optical connection unit 306, the MCF 307, the fiber collimator 308, and the irradiation optical system 309, and scan is performed. More specifically, the irradiation optical system 309 irradiates different positions on the X-Y plane of the object to be measured 320 with the plurality of object light beams 310a and 310b, and scans a certain range.

The object light beams 310a and 310b with which the object to be measured 320 is irradiated are scattered backward (in a direction opposite to the radiation direction of the object light beam) from the object to be measured 320. Then, the object light beams (backscattered light) R31 and R32 scattered from the object to be measured 320 are input to the coherent light receiver 311 via the irradiation optical system 309, the MCF 307, and the plurality of circulators 304.

The plurality of reference light beams R21 and R22 output from the second optical splitter 305 is input to the coherent light receiver 311.

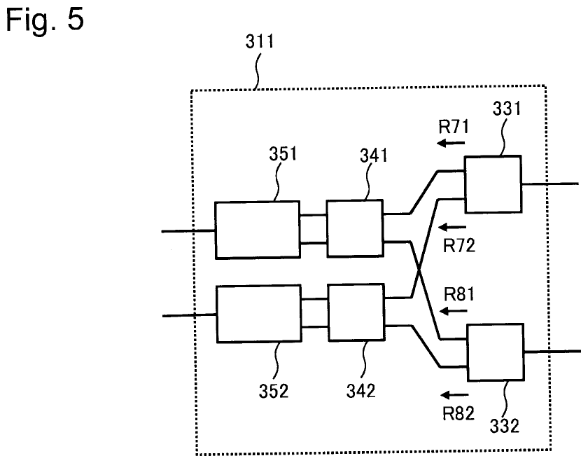

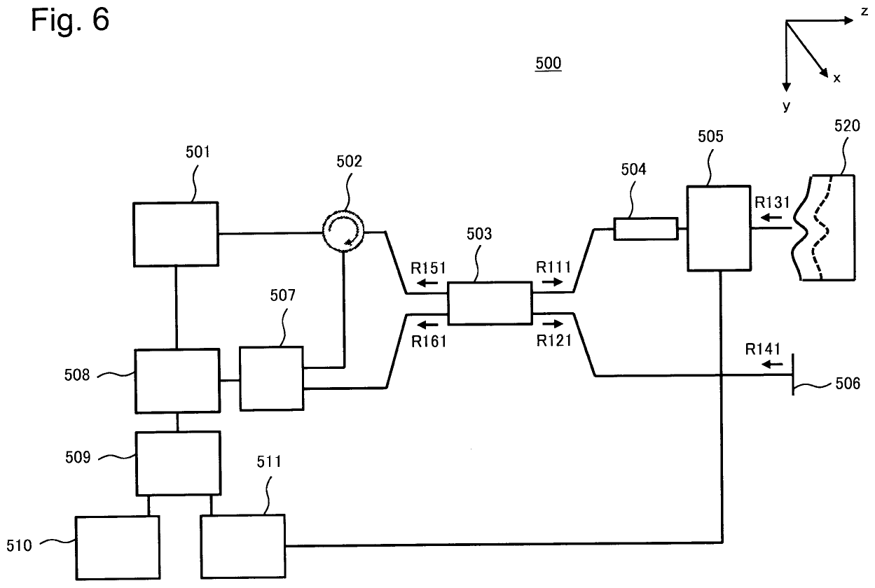

An internal configuration example of the coherent light receiver 311 that causes the object light beam and the reference light beam to interfere with each other is illustrated in FIG. 5. The object light beam is split into object light beams R71 and R72 by a splitter 331, and guided to merging units 341 and 342, respectively. The reference light beam is split into reference light beams R81 and R82 by a splitter 332, and guided to merging units 341 and 342, respectively. In the merging unit 341, the object light beam R71 and the reference light beam R81 interfere with each other, and in the merging unit 342, the object light beam R72 and the reference light beam R82 interfere with each other. The optical path length from the splitter 332 to the merging unit 341 and the optical path length from the splitter 332 to the merging unit 342 are set such that a difference therebetween is a half wavelength. Therefore, the phase difference between the object light beam R71 and the reference light beam R81 interfering at the merging unit 341 and the phase difference between the object light beam R72 and the reference light beam R82 interfering at the merging unit 342 are different by π. The two light outputs of the merging unit 341 are input to a balance type light receiver 351 to obtain the photoelectric conversion output of the intensity difference between the two light beams. The two light outputs of the merging unit 342 are input to the balance type light receiver 352 to obtain the photoelectric conversion output of the intensity difference between the two light beams. Outputs of the balance type light receivers 351 and 352 are input to the light spectrum data generation unit 312.

The light spectrum data generation unit 312 generates interference light spectrum data based on the information on the wavelength change of the emission light from the wavelength swept laser light source 301 and the information on the change in the interference light intensity ratio between the object light beam R31 and the reference light beam R21 from the coherent light receiver. Similarly, the light spectrum data generation unit 312 generates the interference light spectrum data based on the information on the wavelength change of the emission light from the wavelength swept laser light source 301 and the information on the change in the interference light intensity ratio between the object light beam R32 and the reference light beam R22 from the coherent light receiver.

The interference light spectrum data generated by the light spectrum data generation unit 312 reflects a difference between an optical path length until the reference light beam reaches the optical merging unit inside the coherent light receiver 311 after the reference light beam is split by the second optical splitter 305 and an optical path length until the object light beam is irradiated to the object to be measured 320, backscattered, and reaches the optical merging unit inside the coherent light receiver 311 after the object light beam is split by the second optical splitter 305. The SMF is used for an optical path until the reference light beam reaches the optical merging unit inside the coherent light receiver 311 after the reference light beam is split by the second optical splitter 305, and the optical path length is P_{R}. On the other hand, the MCF having the length L₁ and the optical path length P₁, and the SMF having the length L₂, and the optical path length P₂ is used for the optical path until the object light beam is backscattered at one light scattering point of the object to be measured 320 and reaches the optical merging unit inside the coherent light receiver 311 after the object light beam is split by the second optical splitter 305, and the optical path length is P_{S}=P₁+P₂+z₀. Using the equivalent refractive index n_{M} of the MCF, the equivalent refractive index n_{S} of the SMF, and the difference Δn thereof, the following is expressed.

P₁+P₂−P_{R}=n_{M}L₁−n_{S}(L₂−L_{R})=ΔnL
When the amplitude of the interfering object light beam is E_{S} and the amplitude of the reference light beam is E_{R}, the following is expressed.

I(k)∝E_{S}·E_{R}·exp[i(kz₀+kΔnL+ϕ)] [Math. 6]

The interference light spectrum data represented by the above expression is generated by the light spectrum data generation unit 312. By using the coherent light receiver, it is possible to detect a state in which interference between the object light beam and the reference light beam differs by the phase difference π (quadrature phase). A term represented by kΔnL appears in the phase term of the interference light spectrum data, and is not proportional to k. The following multiplication process is performed via the wavelength dispersion compensation processing unit 313.

I(k)·exp(−ikΔnL)∝E_{S}E_{R}·exp[i(kz₀+kΔnL+ϕ]·exp(−ikΔnL) [Math. 7]

Therefore, by the Fourier transform performed by the A scan waveform generation unit 314 the following is expressed.

□(□)=|∫□(□)□^{-□Δ□□□}□^{□□□}∝□(□−□₀) [Math. 9]

A peak of a δ function is shown at z=z₀, and an A scan waveform for one light scattering point position is obtained without degradation in position resolution.

The A scan waveform generation is repeatedly performed while the radiation positions of the object light beams R11 and R12 are moved in the scanning line direction (X direction) by the irradiation optical system 309 based on the control by the object light beam radiation position setting unit 316, and by connecting the measurement results, a map of the two-dimensional intensity of the backscattered light (object light beam) in the scanning line direction and the depth direction is obtained as the B-scan tomographic structure data.

Further, the three-dimensional tomographic structure data in the X, Y, and Z directions is generated by connecting the measurement results obtained by repeatedly performing the B scan operation while moving the radiation positions of the object light beams R11 and R12 in the scanning line direction and the direction perpendicular to the scanning line based on the control by the object light beam radiation position setting unit 316 (C scan).

### (Effects of Example Embodiment)

As in the above-described first example embodiment, in the optical interference tomographic imaging device 300 of FIG. 4, the plurality of object light beams R11 and R12 output from the second optical splitter 305 is coupled in the MCF 307 by the optical connection unit 306, and is irradiated to the object to be measured 320 via the irradiation optical system 309 and scan is performed. As a result, it is possible to achieve the irradiation optical system used for the irradiation with the plurality of object light beams without changing the irradiation optical system used for the irradiation with the single object light beam.

As in the first example embodiment described above, even in a case where the wavelength dispersion of the optical path of the object light beam is different from the wavelength dispersion of the optical path of the reference light beam, it is possible to suppress degradation in spatial resolution of the scanning waveform by compensating for the difference in wavelength dispersion.

While the invention has been particularly shown and described with reference to example embodiments thereof, the invention is not limited to these example embodiments. It will be understood by those of ordinary skill in the art that various changes in form and details may be made therein without departing from the spirit and scope of the present invention as defined by the claims.

### Reference Signs List

100, 300 optical interference tomographic imaging device
101, 301 wavelength swept laser light source
102 optical splitter
103, 303 optical delayer
104, 304 circulator
105 optical splitting/merging unit
106, 306 optical connection unit
107, 307 MCF
108, 308 fiber collimator
109, 309 irradiation optical system
110a, 110b, 310a, 310b object light beam
111 SMF
112 reference light beam mirror
113 balance type light receiver
114, 312 light spectrum data generation unit
115, 313 wavelength dispersion compensation processing unit
116, 314 A scan waveform generation unit
117, 315 tomographic image generation unit
118, 316 object light beam radiation position setting unit
120, 320 object to be measured
311 coherent light receiver
302 first optical splitter
305 second optical splitter

What is claimed is:

1. An optical interference tomographic imaging device comprising:
a wavelength swept laser light source;
a memory; and
at least one processor coupled to the memory
the at least one processor performing operations to:
split light emitted from the wavelength swept laser light source into object light beam and reference light beam;
irradiate an object to be measured with the object light beam output, and scan a predetermined range;
generate information on wavelength dependency of an intensity ratio of an interference light beam between an object light beam, irradiated to and scattered by the object to be measured, and the reference light beam;
perform compensation for the information on the wavelength dependency of the intensity ratio of the interference light beam generated, the compensation being carried out by using a multiplication process based on a difference in wavelength dispersion of an optical path of the object light beam and an optical path of the reference light; and
generate tomographic structure information on the object to be measured, based on a result of the compensation.

2. The optical interference tomographic imaging device according to claim 1, wherein the at least one processor further performs operation to:
after the object light beam output is further split into a plurality of light beams, irradiate the object to be measured and scan a predetermined range.

3. The optical interference tomographic imaging device according to claim 1, wherein the at least one processor further performs operation to:
after the object light beam output is further split into a plurality of light beams, irradiate the object to be measured using a multi-core optical fiber and scan a predetermined range.

4. The optical interference tomographic imaging device according to claim 1, further comprises:
a balance type light receiver that generates information on an intensity ratio between an object light beam, irradiated to and scattered by the object to be measured, and the reference light beam.

5. The optical interference tomographic imaging device according to claim 1, further comprises:
a coherent light receiver that causes an object light beam, irradiated to and scattered by the object to be measured, and the reference light beam to interfere with each other.
